(19) United States
(12) Patent Application Publication
(10) Pub. No.: US 2010/0118912 A1
(43) Pub. Date: May 13, 2010

(54) QUALITY CONTROL OF THE FRIT FOR OLED SEALING

(76) Inventors: Changyi Lai, Painted Post, NY (US); Stephan Lvovich Logunov, Corning, NY (US); John David Lorey, Corning, NY (US); Vitor Marino Schneider, Painted Post, NY (US)

Correspondence Address: CORNING INCORPORATED, SP-TI-3-1, CORNING, NY, 14831, US

(21) Appl. No.: 12/267,737

(22) Filed: Nov. 10, 2008

(51) Int. Cl. G01N 25/18

(52) U.S. Cl. 374/5

(57) ABSTRACT

A method of finding defects in sealing material formed as a frame line on a glass plate includes irradiating the frame line of sealing material. A temperature of the irradiated sealing material is measured and a change of the temperature caused by a nonuniformity in sealing material is detected. Another aspect features a method of hermetically sealing a thin film device between glass plates. Sealing material is dispensed on a cover glass plate in the form of a frame line cell. The sealing material is pre-sintered onto the cover glass plate and cooled. A laser beam is moved around the frame line on the sealing material. A temperature of the sealing material contacted with the laser beam is measured. A change in the temperature (ΔT) caused by a nonuniformity in the sealing material is measured. Further aspects include a feedback process, infrared imaging and use of delta temperature data to increase sensitivity of temperature measurement data.

### TECHNICAL FIELD

The present disclosure is directed to a process for detecting defects in sealing material used for hermetically sealing thin film devices (e.g., OLED devices) between glass plates.

### TECHNICAL BACKGROUND

OLEDs (organic light emitting diodes) have been the subject of considerable research in recent years because of their use in a wide variety of electroluminescent devices, including GPS units, cell phones, cameras and televisions. A single OLED can be used in a discrete light emitting device or an array of OLEDs can be used in lighting applications or flat panel display applications (e.g., OLED displays). OLEDs are solid state devices made of thin organic molecules that create light with the application of electricity. Primary advantages of these devices are a crisper, brighter display than an LCD that also uses less power. OLED displays are known to be very bright and to have a good color contrast and wide viewing angle. However, OLED displays and, in particular, the electrodes and organic layers located therein are susceptible to degradation resulting from interaction with oxygen and moisture leaking into the OLED display from the ambient environment. Unfortunately, in the past it has been very difficult to develop a sealing process to hermetically seal the OLED display. Historically, epoxies have been used to hermetically seal the displays but moisture still permeates the seal to shorten life.

Processes are known to drastically improve the hermeticity of the OLED displays by using a dispensed glass frit bead around the device sealed using a laser to seal the back-plane to the cover sheet. Among other things, the temperature generated during the sealing process should not damage the materials (e.g., electrodes and organic layers) within the OLED display. For instance, the first pixels of the OLEDs which are located about 1-2 mm from the seal in the OLED display should not be heated more than 100° C. during the sealing process.

Typically, frame lines of a bead of sealing material for each OLED display are formed and pre-sintered onto a cover sheet. Hundreds or thousands of OLED displays (e.g., in 1×1 inch areas) can be formed on a single substrate. The cover sheet is then positioned so that the frame lines are disposed around each OLED display on the substrates. One way to hermetically seal the frame line of sealing material on the cover sheet to the substrate that supports the corresponding OLED display is by melting the low temperature frit sealing material doped with a material that is highly absorbent at a specific wavelength of light. In particular, a high power laser is used to heat up and soften the frit which forms a hermetic seal between the cover glass with the frame of frit thereon and the substrate glass with OLEDs located thereon. The frit is typically about 1 mm wide and about 6-100 μm thick. If the absorption and thickness of the frit is uniform then sealing can be done at constant laser energy and speed so as to provide a uniform temperature rise at the frit location.

The dispensing of the frit on the cover glass for OLED sealing occasionally suffers from the presence of defects such as high spots, voids and thickness variations. These types of defects may create sealing defects leading to failure of the product. The overall process suffers from low yield due to the presence of defects. A significant amount of work has been done to improve the quality of dispensing but sealing yields are still a problem. The topography of the dispensed frit can be monitored with a low coherency interferometer or optical microscope, but these are very slow or expensive processes.

There is a need for a high speed, low cost process for inspecting the quality of material used to seal thin film devices between glass plates.

### SUMMARY

A first embodiment of this disclosure is a method of finding defects in sealing material formed as a frame line on a glass plate. A frame line of the sealing material is irradiated. A temperature of the irradiated sealing material is measured. A change in temperature (ΔT) caused by a nonuniformity in the sealing material is detected.

Referring to specific aspects of the first embodiment, the sealing material can be a frit. The frame line of sealing material can be pre-sintered onto the glass plate. The frame line of sealing material can be rejected if the temperature change (ΔT) is detected. The irradiation can be carried out by applying a laser beam onto the frame line of sealing material. The temperature change can be measured using an optical pyrometer mounted onto a head of the laser.

In an off-line aspect of this disclosure, the laser is operated at a laser power P wherein P₁<P<P₂, where P₁ is a laser power that raises a temperature of the sealing material to a sensitivity of the optical pyrometer and P₂ is a laser power that raises the temperature of the sealing material to its melting point.

In an on-line aspect of this disclosure, the glass plate with a pre-sintered frame line of sealing material is placed over a substrate glass plate on which a thin film device (e.g., OLED display) is supported to position the thin film device within the frame. The irradiation is carried out by applying a laser beam onto the frame line of the sealing material at a power effective to seal the sealing material to the substrate glass plate. Thus, detection of the temperature changes occurs during normal laser sealing of the frit of the OLED display.

In a feedback aspect of the disclosure, also an on-line process, a laser beam is moved around the frame line. The laser is operated at the sealing power in an absence of the temperature change (ΔT), operated at a lower power soon after the temperature change (ΔT) is detected, and then the power is raised back to the sealing power following the temperature change. The temperature can be measured at a location that leads a location at a center of the laser beam to account for the rate of movement of the laser relative to the glass sheets.

In the disclosure, certain temperature change (ΔT) conditions (thermal signatures) have been identified where a frit line defect is likely to occur:

a) ΔT>40° C. on sides of the frame line,

b) ΔT>60° C. near corners of the frame line, and

c) ΔT<20° C. (as a temperature decrease) on sides and near corners of the frame line.

The frame line can be rejected when the temperature change ΔT conditions a), b) or c) occur. Moreover, if any of the a), b) or c) ΔT conditions occur an optical microscope can be used to view the frame line (or the glass plates) to characterize a defect therein.

A second embodiment of this disclosure is a method of hermetically sealing a thin film device between glass plates. Sealing material is dispensed on a cover glass plate in the form of a frame line cell. The sealing material is pre-sintered onto the cover glass plate and cooled. A laser beam is moved around the frame line on the sealing material. A temperature of the sealing material contacted with the laser beam is measured. A change in the temperature (ΔT) caused by a nonuniformity in the sealing material is detected.

Regarding specific aspects of the second embodiment, the cover glass plate has at least one of the cells pre-sintered thereon and the substrate glass plate has at least one thin film device formed thereon. The cover glass plate is positioned such that the frame line of sealing material is disposed around an outside of the thin film device. During on-line processing, the laser beam is applied at a power effective to seal the sealing material to the substrate glass plate. Thus, the temperature change detection occurs during normal laser sealing of the frit of the OLED display.

In one aspect, an infrared imaging device is used to observe the sealing material while the cover glass plate and the sealing material are inside a furnace during the pre-sintering. The temperature change (ΔT) is detected based on the observation.

In another aspect of this disclosure, the temperature measuring step includes obtaining temperature versus time data for each of the cells. The time is the time in which the laser travels around the cell while obtaining the measured temperature. Average temperature versus time data is obtained for all of the cells or representative temperature versus time data is obtained for one of the cells without the temperature change. The temperature versus time data of a potentially defective cell is subtracted from the average data or from the representative data to produce “delta T” data. The delta T data is evaluated for the detected temperature change (ΔT). The delta T data is evaluated for any of the conditions a)-c) above and a cell satisfying any of the conditions may be rejected. The frame line of such a cell (or the glass of such a cell) may be viewed with an optical microscope to characterize a defect therein.

This disclosure shows that good quality and quantity of information can be obtained from the thermal detector during or before an OLED sealing process. This leads to improved process control thereby leading to lower levels of defects. Also achieved is good accuracy of predicting hermeticity failures based on the thermal signatures. Also, by detecting defects at the seal and providing appropriate feedback immediately to upstream processes, significant cost savings could be realized in production settings.

### BRIEF DESCRIPTION OF THE DRAWINGS

FIG. 1 is a schematic view of a laser apparatus used in the present disclosure;

FIG. 2 is a schematic view of a laser aim beam and thermal detector aim beam on a bead of frit in the form of a cell;

FIG. 3A is a typical sealing thermal response curve of temperature as a function of time of travel of a laser beam around a cell and FIG. 3B is a schematic view of the travel of the laser and dispensing of the frit;

FIG. 4 is a laser sealing thermal response curve of temperature as a function of time of travel of a laser beam around a cell in which a temperature spike is observed;

FIGS. 5A and 5B are laser sealing thermal response curves of temperature as a function of time of travel of a laser beam around a cell in which temperature change peaks are observed;

FIG. 6 shows laser sealing thermal response curves of temperature as a function of time of travel of a laser beam around 49 cell traces all plotted on the same figure, where a sharp, high peak and a broader, lower peak are noted;

FIG. 7 shows laser sealing response curves of temperature as a function of time of travel of a laser beam around a cell or cells showing the average trace from a plurality of cell line traces, a cell line trace of interest, and the difference between them shown as a delta trace;

FIG. 8 shows laser sealing thermal response curves of temperature as a function of time of travel of a laser beam around a cell or cells;

FIG. 9 shows laser sealing thermal response curves of temperature as a function of time of travel of a laser beam around a cell or cells; and

FIG. 10 shows laser sealing thermal response curves of temperature as a function of time or travel of a laser beam around a cell or cells.

### DETAILED DESCRIPTION

In an off-line embodiment the cover sheet carrying pre-sintered frit cells has not yet been placed over the substrate with OLED displays formed on it. A thermal detector supported on a laser sealing head is used as a quality monitoring tool. A dispensing irregularity or poor contact between the frit and the glass, for example, will cause a temperature change of the frit when impinged upon by the laser. This temperature change is monitored using the thermal detector, which detects (raises a “red flag” about) possible defects. Because sealing is one of the last steps in the OLED display manufacturing, predicting a failure can maximize yield. The frit is exposed at a relatively low laser power below the power used for sealing, to raise the temperature of the frit, for example, to about 250-280° C., and the heat signal response is monitored. A temperature deviation from a uniform or baseline reading may indicate a “bad” part. Then, this part might not be used in an actual sealing process.

In another embodiment, the thermal detector on the laser sealing head can be used as an on-line optimization tool during an actual frit sealing process. The temperature measurement and detection of temperature changes occurs while the frit is being sealed at normal laser sealing power and during a normal laser sealing process of the OLED display. The temperature changes observed from temperature versus time curves produced by the thermal sensor can be used to decide if the particular OLED display should be rejected or not.

Rules can be specified during off-line or on-line quality control monitoring to predict the type of defect and potential for failure that occur with certain temperature variations (referred to as temperature signatures in this disclosure). Examples of ΔT conditions that can be used to determine hermeticity failures as well as defect types:

a) ΔT>40° C. on sides indicates potential failure that is probably due to a delamination between the frit and cover sheet.

b) ΔT>60° C. on corners indicates potential failure that is probably due to a delamination between the frit and cover sheet.

c) ΔT<20° C. (as a temperature decrease) on sides and corners indicates a potential failure that is probably due to a dispensing error.

Nearly all spikes (i.e., very high peaks) result in cells that have good hermeticity or seal quality (spikes mean a high magnitude of temperature and narrow time width). The spikes are caused by glass surface contamination absorbing laser energy resulting in the observed brief temperature increase or spike.

If any of the ΔT conditions a)-c) are detected when the cell is analyzed on-line or off-line, the cell can be rejected. In this case, the sealing of that OLED cell may not be carried out or may be stopped. During scoring the glass around the cell is cracked to separate the cell from those cells remaining on the sheets. Thus, the rejected cell might not be subsequently scored to remove the display from the other cells on the glass plates. If a ΔT condition for a spike is detected, the frit line of the cell is probably not defective. Such thermal signatures can be ignored. On the other hand, the glass can be inspected to see if there is a severe smear or a scratch, or the cell itself can be further examined under the optical microscope to see if a frit line defect has resulted.

In another feedback aspect of this disclosure, based on the temperature spike detection or “red flag” signal from the low laser power scanning, it should be feasible to vary the laser sealing power on-line to compensate for possible defects along the frit line. This may be accomplished by creating a defect versus temperature database that indicates temperature changes that are likely to cause defects (e.g., the ΔT conditions a)-c) above). The laser power might be adjusted when one of the conditions a)-c) has been detected. The on-line power adjustment might be done by programming the laser analog output with respect to a physical position on the frit line where the temperature change is detected. When there is a significant temperature change as determined from pre-determined observation (such as according to the thermal signature conditions) the power would be immediately dropped and then when the temperature decreases, or after a predetermined duration, the laser power would be raised again to reach the target temperature. Because of the rate at which the laser beam travels along the frit line during laser sealing, this feedback process would benefit from moving an aim beam of the thermal detector (near where the thermal detector records temperature) so that it is spaced forward from the center of the laser aim beam (near where the laser beam will contact the frit line). The feedback method might result in OLED displays being saved from hermeticity failure because adjusting power might result in proper sealing despite a defect in the frit line.

In another aspect of the disclosure, in addition to or instead of pre-sealing (off-line) or sealing (on-line) frit line inspection, thermal images from an IR camera might be used for inspection of frit lines during pre-sintering. A thermal detector integrated with a vision system might be used in this application. The thermal image may be obtained from the sintering oven from a safe observation spot with the aid of a vision system. The temperature of the pre-sintering oven is, for example, from room temperature to about 450° C. as is known in the art. In the 1000 to 2000 nm wavelength range the frit material radiates as a gray body on clear glass. The emission of the frit and the glass differ. All volume of the frit, not just the frit at the surface, would produce thermal radiation. It is estimated that the pre-sintering oven maximum temperature may be sufficient to provide enough contrast in the thermal imaging to see frit line defects while the frit is being pre-sintered to the cover sheet.

The inventive temperature change detector of the frit for OLED sealing is a quality control monitoring tool that detects irregularities of frit dispensing. Any irregularities of the frit can be detected, including voids in the frit, poor contact between the frit and the glass, fibers on the glass, smears or scratches on the cover glass plate, frit delamination and variations in height and/or width of the frit. The height of the dispensed frit bead after pre-sintering can be on the order of 15 μm (e.g., ±2 μm). The width of the bead of frit can be about 0.7 mm. The laser spot has a wider area (e.g., several hundred microns) than the width of the frit.

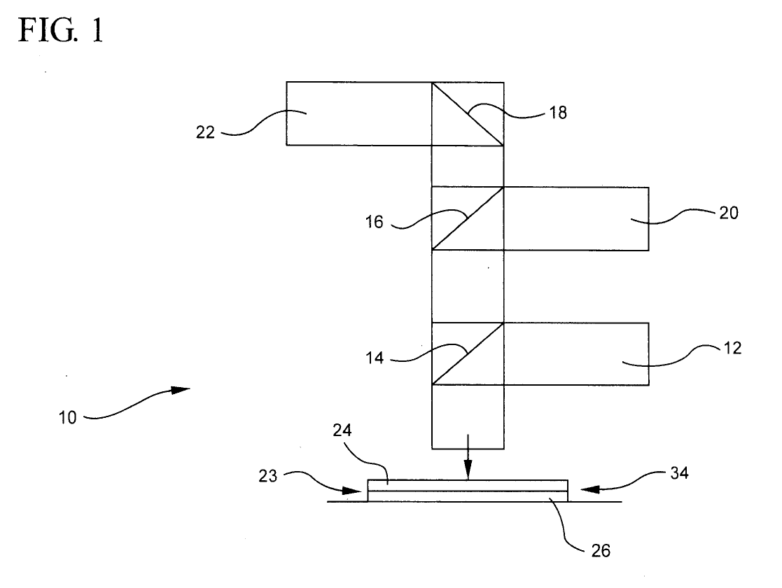

Referring to the drawings, FIG. 1 is a schematic view showing an optical pyrometer thermal detector 10 on a head of a laser 12 for sealing with frit. Included are dichroic mirrors 14, 16 and 18. Mirror 14 reflects approximately 800-900 nm wavelength light and transmits light below this wavelength. A CCD camera 20 captures pictures of sealing frames for alignment of the laser; the laser and pyrometer aim beams are seen with this camera. An IR filter (not shown) is placed in front of the CCD camera so it is not blinded by the IR radiation. Mirror 16 reflects visible light from the frit to the CCD camera. Mirror 18 reflects infrared light from the irradiated frit to the optical pyrometer but excludes laser light and visible light. The optical pyrometer 22 is, for example, a single color optical pyrometer from Laserline Inc., which observes the temperature of radiation in the 1000-2000 nm range. The pyrometer is attached to the laser head. The working wavelength range of the pyrometer is selected because borosilicate display cover glass absorbs light greater than 2500 nm. Therefore, the pyrometer is selected to operate in a wavelength range shorter than this. In operation, the light from a diode laser in the 800-900 nm wavelength range is delivered using a single core fiber or fiber bundle. The laser is focused through a focusing lens (not shown). The frit 23 is pre-sintered onto a cover sheet 24 and can be sandwiched between the cover sheet and a substrate glass sheet 26. The laser light is reflected by mirror 14 to the frit. IR radiation emitted from the laser contacting the frit 23 passes through mirror 14 and mirror 16 and is reflected by mirror 18 to the optical pyrometer 22. The visible light source coupled with the camera radiates the sample through the mirror 14, and reflected visible light, but not laser light is reflected back by mirror 16 to the CCD camera 20. This laser assembly was used in all of the examples discussed below.

The device and process disclosed here were not limited to the particular glass or frit that were used. Some typical display glasses that can be used are Corning Inc.'s Code 1737 glass, EAGLE® glass and EAGLE XG® glass. Soda lime glass and Corning Inc.'s VICOR® glass and HPFS® fused silica might also be suitable. Although the cover glass should be clear at the laser wavelength, the substrate can be clear or opaque at that wavelength. The term “clear” does not imply perfect transmittance. Examples of possible frit and non-frit sealing material are disclosed by the following patents: U.S. Pat. Nos. 7,407,423; 6,998,776; 7,344,901; and 7,371,143; these patents are incorporated herein by reference in their entireties for the disclosure of such sealing materials as well as for disclosure of OLED displays and for general laser sealing processes. While this disclosure refers to the frit as a sealing material, it should be appreciated that sealing material besides frit can be used.

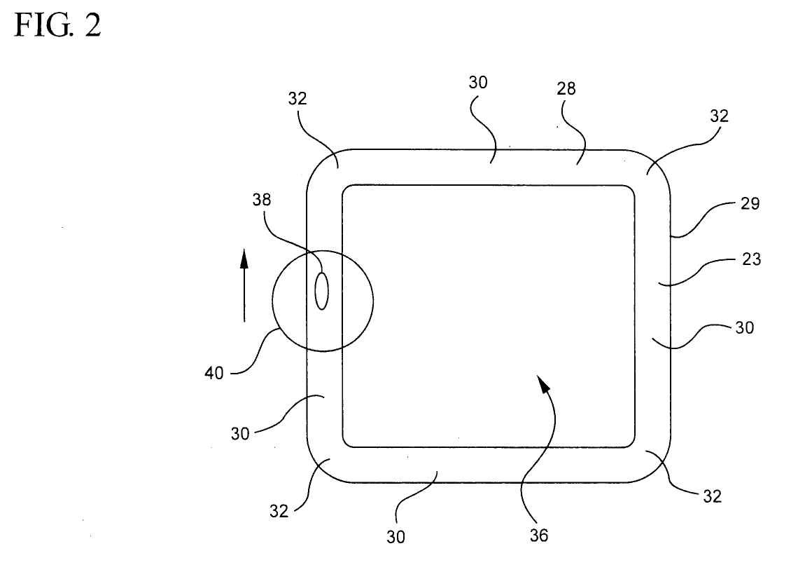

FIG. 2 shows a schematic top view of laser and optical pyrometer aim beams on a frit frame or cell 28 for use sealing an OLED display. The cell has sides 30 and corners 32. The frit 23 is located as a bead of a certain height having the shape and width of the frame 28. The frit cell was pre-sintered onto a glass cover sheet 24 (FIG. 1). The term “pre-sintering” is used to describe the sintering that occurs before laser sealing of the frit onto the substrate. The OLED display, a thin film device shown generally at line 34 in FIG. 1 (and at a location 36 in FIG. 2), was sandwiched between a substrate glass 26 on the bottom and the cover glass 24 on the top and was hermetically sealed with the frit material disposed around it as disclosed, for example, in the U.S. Pat. Nos. 7,371,143 and 7,344,901 patents. The frit seal is normally located just outside the outer edge of the OLED display. The optical pyrometer has a small laser that produces a visible light aim beam 38 which identifies the same spot size and shape as where the pyrometer signal is taken from. The sealing laser also has a visible light aim beam 40 that is visible to the CCD camera and identifies the same spot size and shape as where the sealing laser beam contacts the frit. The thermal detector aim beam 38 is smaller than the sealing laser aim beam 40 and nearly elliptical. During the feedback process the aim beam 38 of the thermal detector would be moved so that it is spaced more leading relative to the center of the laser aim beam 40.

The frit was dispensed as a bead in the form of the frame or cell (frame cell) on the cover sheet corresponding to each OLED display formed in a grid of cells at predetermined locations on the substrate. The frit was dispensed in a consistency of a paste using a micropen dispenser (or might be dispensed using screen printing) as known in the art. The cover glass with the frit beads formed on it (and without the OLEDs devices) was pre-sintered in an oven in a known manner. This pre-sintering temperature does not significantly affect the display glass. Organics in the frit were removed during pre-sintering. The cover glass and pre-sintered frit were then cooled. There may or may not be IR camera monitoring of the frit during pre-sintering. Also, there may or may not be a low power, off-line temperature change detection before sealing as discussed below.

In off-line quality control monitoring of the frit, the cover sheet with pre-sintered frit cells formed on it is faced downward so that the frit contacts a reference plate supported on an xyz table (i.e., a table movable in any xyz direction). The cover sheet is held to the reference sheet by clamping or with suction. The beam of the low power laser with thermal detector on the laser head passes through the cover glass, is absorbed by the frit and the radiation emitted from the frit travels upward from the frit through the cover glass and to the optical pyrometer for measurement.

To achieve hermetic sealing, the side of the cover glass plate with the pre-sintered frit is aligned relative to the substrate glass having the thin film devices (e.g., OLED displays) formed on it. For example, in commercial production the substrate sheet can have several hundred or thousand, e.g., 1×1 inch area, OLED displays formed in a grid on it. When the cover sheet is positioned relative to the substrate each of the OLED displays is placed within a corresponding frit line cell. The frit has a much lower melting point than the glass. To seal the frit using the laser at higher sealing power, the laser is applied through the cover glass or through the substrate glass onto the frit material, which absorbs the laser energy and brings the two glass plates together once the frit is melted. The hermetic sealing of each cell was achieved after the laser beam from the laser sealing head moved continuously, completely around the cell (e.g., in a clockwise direction). The on-line temperature change detection quality control monitoring tool of the present invention would be utilized during this sealing. The optical pyrometer would detect the radiation emitted from the frit (through the cover sheet) after it is irradiated by the laser at sealing power. As in typical laser frit sealing of OLEDs, the laser will be operated so as not to raise the temperature near the position of the OLED above about 90 to 100° C. The cover glass and substrate will then be scored around each hermetically sealed area and the displays separated from the sheets to produce individual OLED displays. This disclosure did not use a substrate having OLEDs formed on it but rather sealed the presintered fritted cells on the cover sheet of display glass to a blank substrate of display glass.

As examples of the laser parameters, the laser can be a diode laser emitting light having a wavelength of 800-980 nm. Other lasers may also be suitable, such as a laser emitting light having a wavelength of about 530 nm. The laser power can range from 20 to 1 kW. The amount of power used depends on various factors known in the art including the laser speed and spot size. The laser power will vary depending on whether the process is used during sealing (online) or before sealing (off-line). For example, when the temperature change detection process is used on a pre-sintered frit on the cover sheet, the power is between the sensitivity of the optical pyrometer (e,g., about 200 to 250° C.) and the melting point of the frit. When used online during frit sealing, the laser sealing power would be selected to be sufficient to melt the frit (e.g., 500 to 550° C. target). The rate of the movement of the laser relative to the table supporting the glass sheets (i.e., by moving either the laser or the table while keeping the other still) can vary as known in the art.

Reference will now be made to the following examples, which should not be used to limit the claimed invention in any way.

### EXAMPLE 1

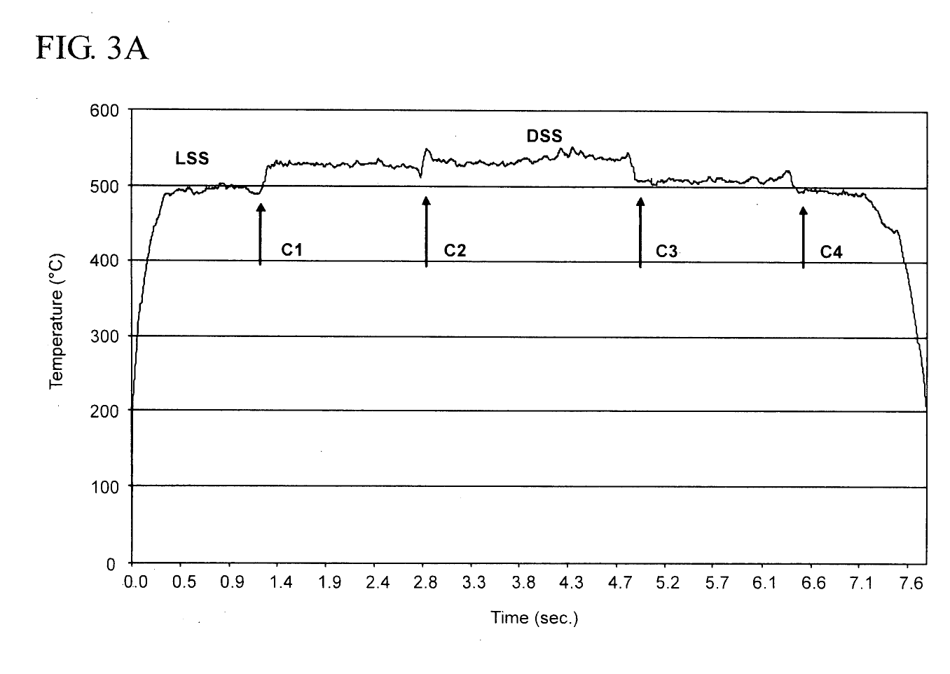

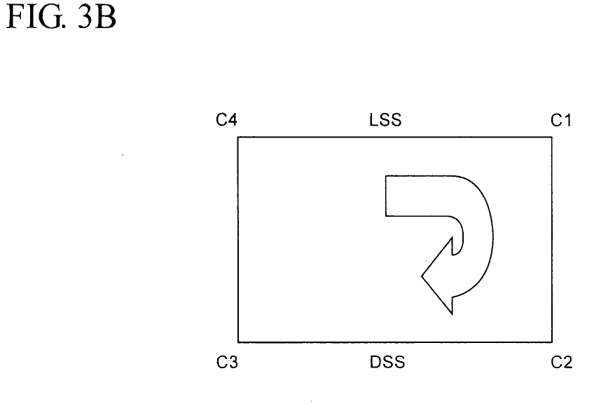

FIG. 3A shows a typical temperature profile using a thermo-detector on a laser sealing head described above as generally shown in FIG. 1. For this and the other examples, the laser power was 27-30 W and the laser beam was moved around the frit frame lines at a speed of 50 mm/sec. The frit frame lines were pre-sintered onto the cover display glass (heating from room temperature to about 450° C.). The frit on the cover glass sheet was sintered to the substrate display glass sheet by laser sealing. Both the cover sheet and substrate glass sheet were Corning Eagle XG® glass. The substrate had no OLED displays formed on it.

FIG. 3B shows the direction of frit dispensing from a micropen dispenser: in the clockwise direction from the dispenser start to the dispenser stop position (dispenser start-stop, DSS). The laser was moved during sealing and thermal detection from the laser start to the laser stop position (laser start stop, LSS). While traveling around the cell, the laser passed around the corners, from corner C1 through to corner C4 and traveled around the sides of the frame. Small temperature steps at C1-C4, corresponding to the four corners of the cell, occurred as seen in FIG. 3A due to misalignment between the laser aim beam and pyrometer aim beam as mentioned above. Although the temperature response curves are shown as a function of time of laser movement, they can easily be used to determine the location along the frit line where the defect has occurred. An optional algorithm was used to smooth the spike widths and height at the corners to achieve a uniformly flat temperature profile through the beam alignment and fine adjustment (the results of which are not shown here). If the OLED display manufacturer employs screen printing to print all of the frit cells at one time onto the cover sheet, this will eliminate the DSS and frit height variations that may exist at these locations.

### EXAMPLE 2

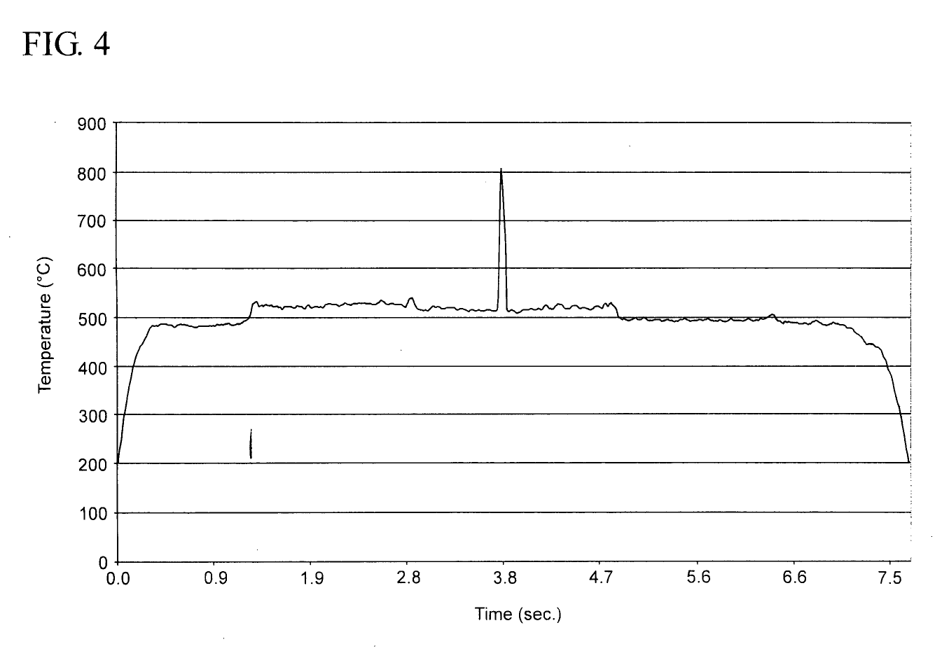

FIG. 4 shows the results of a correlation study between a signature temperature spike (high and narrow peak) and surface contamination on the frit line. The glass surface contaminant leads to different laser energy absorption. Here, the temperature spike was a signature for a defect. The surface contamination on the glass was so bad that the laser light did not fully reach the frit, resulting in a peak in temperature. Normally, as was the case here, a temperature spike results from glass surface contamination and does not represent a frit line defect.

### EXAMPLE 3

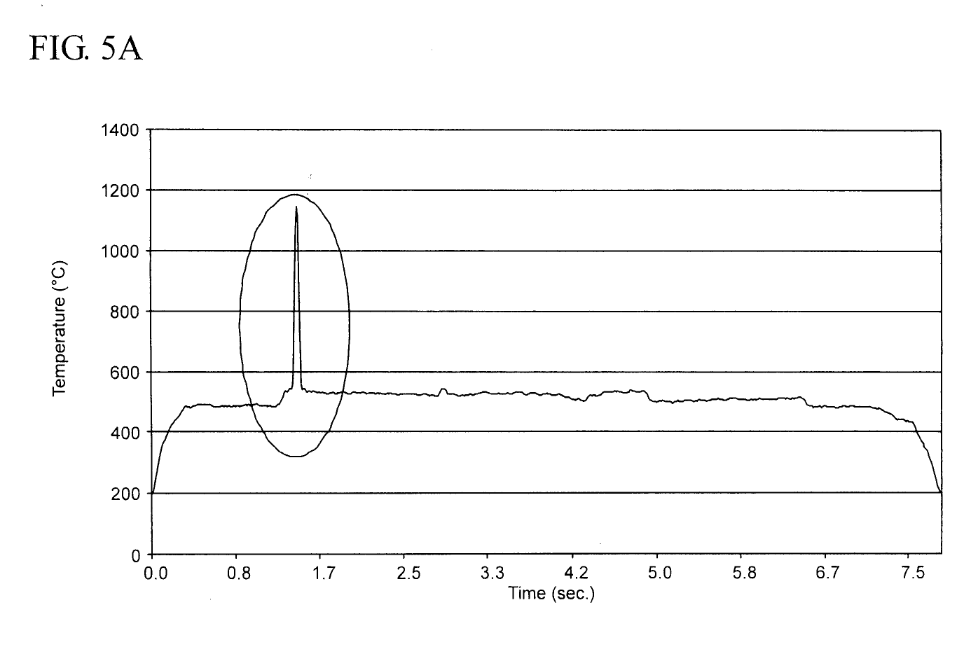

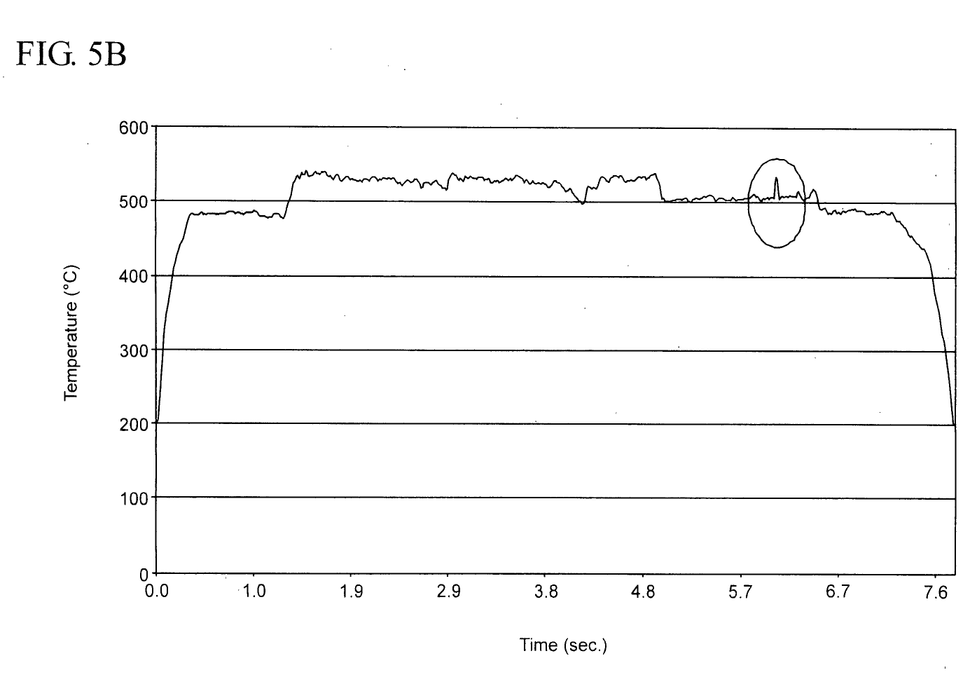

FIGS. 5A and 5B correlate temperature peaks and damaged frit lines. Temperature changes were seen in the thermal profiles of FIGS. 5A and 5B. The presence of a temperature spike (circled) is normally not determinative of whether there is a frit defect. In this rare situation, however, the surface defect of the glass (seen as a smear or scratch) was so severe that the laser light was blocked from reaching the frit and a frit line defect resulted.

FIG. 5B was an example of a glass surface defect and a minimal thermal response. The smear on the cover glass that was located on the cell that produced the thermal signature of FIG. 5A was actually also located on the cell that produced the thermal signature of FIG. 5B. Here, the smear and the minimal frit line damage to the cell were observed by the optical microscope first. This frit line damage did not impact OLED display performance. Next, the thermal response curve was analyzed (FIG. 5B), showing a peak (circled) that was so small it might normally be missed in the background noise if searching for the peak alone not knowing there was a frit line defect.

### EXAMPLE 4

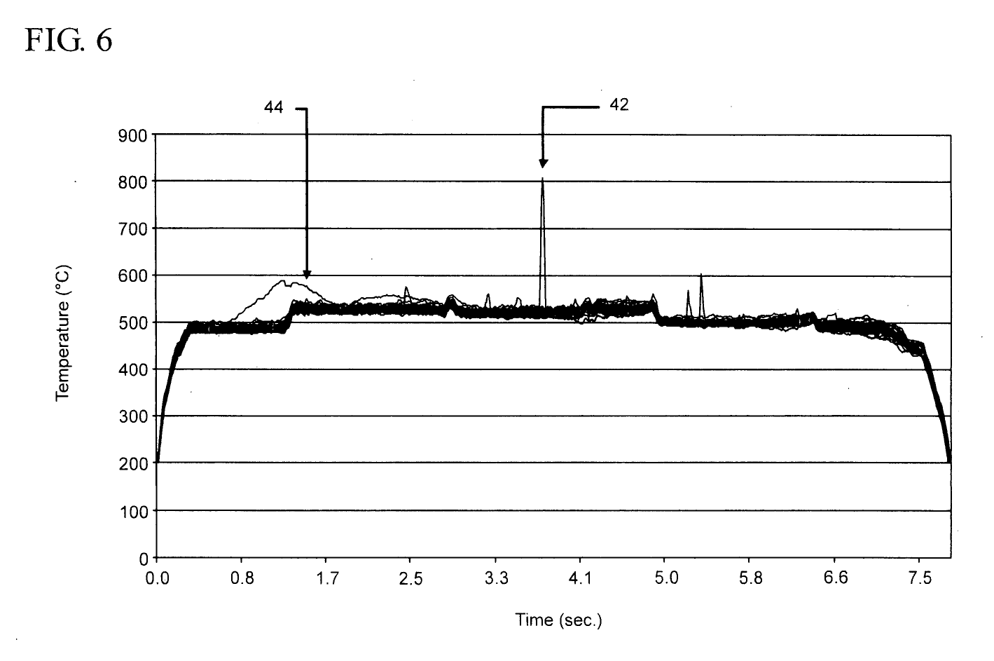

Detecting small thermal anomalies which do not stand out from the background noise of many thermal measurements plotted on the same graph is a concern. FIG. 6 shows the temperature versus time curves for 28 different cells. FIG. 6 shows a plurality of actual traces plotted on the same graph. It is seen that small signals can get lost in the noise when all of the curves are plotted together this way. This figure illustrates a high magnitude, sharp peak (spike 42) at about 800° C. and a lower magnitude and wider peak 44 at 589° C. Peak 42 was caused by surface contamination on the cover sheet and had no impact on seal quality as determined by a water immersion test to ascertain hermeticity. Peak 44 was caused by a partial gap between the cover sheet and frit line and lead to hermeticity failure as determined by the water immersion test. By improving the analysis of data from the thermal detector, significantly more reliable information with respect to defect type, severity and hermeticity may be realized leading to improved feedback to the sealing and dispensing processes.

Because the x axis of the thermal response curves of this disclosure show the travel of the laser based on the time of its movement from a known starting point, a plurality of cells on a grid on the cover sheet can be monitored and analyzed for defects at particular locations along each frit frame line. The grid was displayed by a computer program and the differences in contrast where the defects are observed were highlighted on the cells of the grid where the defects actually occurred. Defects of this particular cell were highlighted on a computer image showing the cell grid. The highlighting showed the place along the frame line of the cell where the defect was actually located. This assists when viewing the cell with an optical microscope as the exact location of the cell where the defect is located is known. The x,y position of the corners of each of the cells is known, which enables locating the corners and thus the sides of the cell (long and short sides are included as “sides” in the above ΔT conditions), which facilitates analyzing the ΔT conditions or thermal signatures.

### EXAMPLE 5

The accuracy of detecting thermal “anomalies or defects” is improved by comparing the actual thermal trace from the cell to a sheet average or a known good “target” or “representative” trace as discussed below. This improves the detection limits of the measurement enabling smaller anomalies (defects) to be detected. Specific “thermal signatures” are defined including sealing defects, dispense errors, cover sheet surface contamination and non-contact between the dispensed frit-line and cover sheet. The approximate magnitude of thermal anomalies is identified by defect type that causes hermeticity failure. For example, a 200° C. spike caused by cover sheet surface contamination has less of an impact on hermeticity than a 60° C. anomaly caused by non-contact (which is addressed by the ΔT conditions specified above).

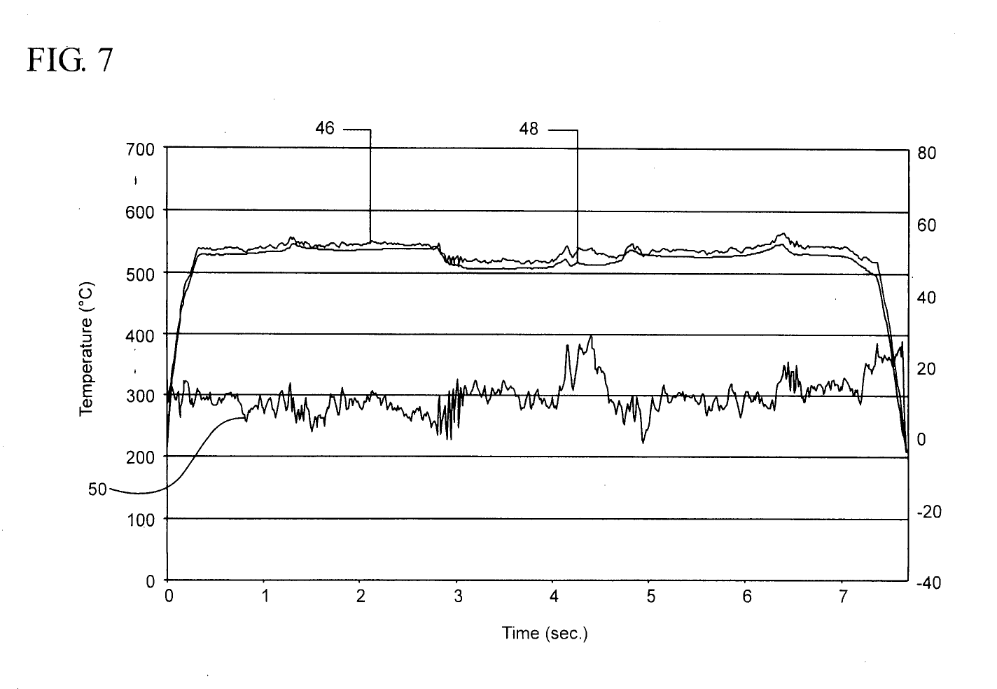

Referring to FIG. 7, trace 46 was the actual seal temperature profile of one trace taken from the thermal detector. Trace 48 was the average seal temperature profile calculated from all cells sealed on the fritted coversheet. In this case 49 cells were averaged. A known good profile (“representative trace”) might also be used to compare to the actual thermal trace to detect possible defects. Use of an average or representative trace is a cleaner, more effective use of the data than in FIG. 6 which put all of the thermal trace curves on a single figure. Trace 50 here was the delta or difference between the actual and the average trace. This step eliminated the background noise that was observed in FIG. 6, thereby drastically improving the defect detection limits of this measurement. Also, by evaluating the width and magnitudes of anomalies in the delta trace, defect sources can be identified by their thermal signatures and hermeticity can be predicted with high probability (e.g., about 99%). Event indicators that marked areas of interest on the average trace could be activated when the delta indicates thermal signatures favor failure. This would enable separating defect thermal signatures that have little impact on seal performance (Peak 42 above in FIG. 6) from probable failures. The locations of the corners of the cell, as determined from the xy intersection point the laser reached traveling around the cells of the grid, could also be determined. It will be appreciated that the conditions can be programmed so as to activate the event indicator, making it easier to spot a potential defect. Alternatively, the program can exclude certain high y values and short x values (spikes), which usually do not affect hermeticity, or other temperature changes. This example applied the ΔT conditions described above.

Of 392 cells that were tested, 5 were predicted to fail by analyzing the thermal response curves, 10 actually failed water immersion testing, 4 unpredicted failures occurred, resulting in 99% accuracy

### EXAMPLE 6

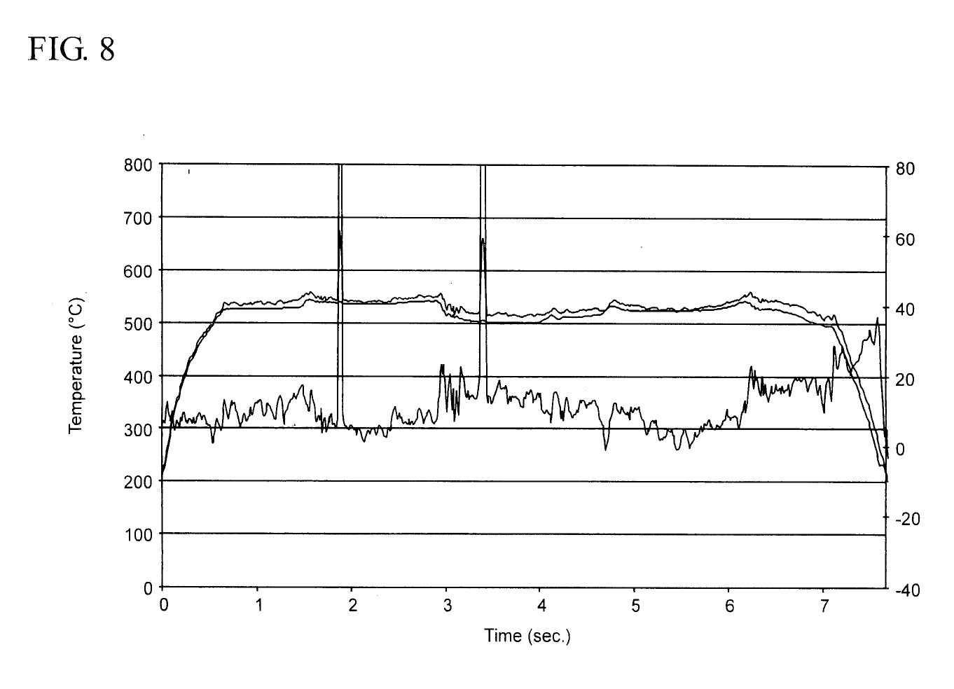

FIG. 8 shows contamination due to spikes (high temperature magnitude and narrow time width). It was found that this produced either a minimal impact on hermeticity or seal quality or none at all. The spikes were caused by surface contamination (e.g., a smear caused by dragging the glass against another surface) absorbing laser energy resulting in the observed brief temperature increase or spike.

### EXAMPLE 7

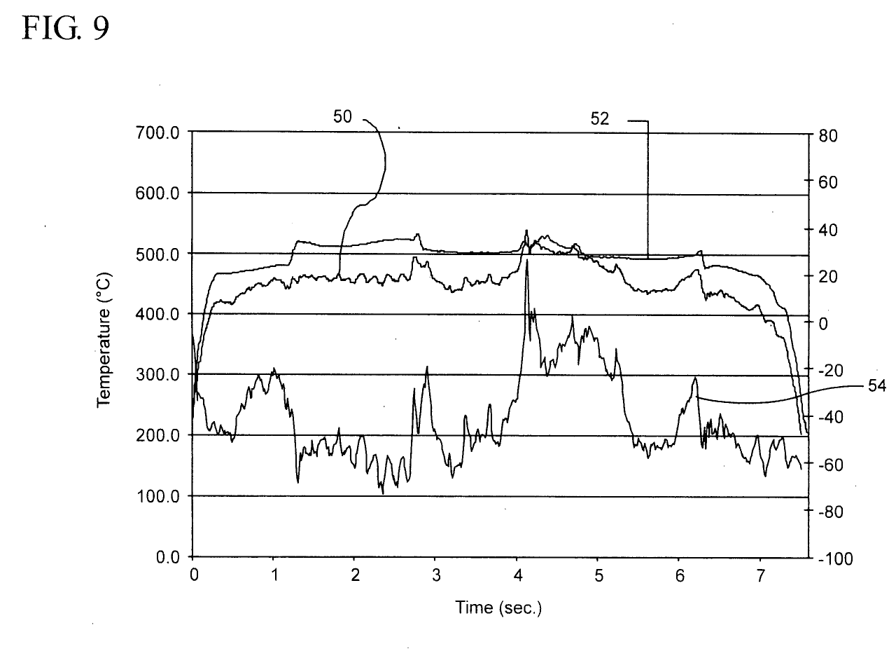

FIG. 9 is a thermal signature of a frit line defect due to contamination on a needle tip during dispensing. The majority of actual thermal trace 50 was lower than average thermal trace 52 (the average of all of the traces that were taken) by 20° C. or more (condition c) above). The change between the actual trace 50 and the average trace 52 was shown by delta trace 54. This could be identified by programming the event indicator to pick up such an occurrence. The observed lower temperature of this single cell trace 50 was due to less laser energy being absorbed by the reduced exposed surface area of the frit line. Other thermal signatures for dispensing defects are possible, such as a low temperature trace on only one side of the cell where dispensing was a problem and then normal (at a similar temperature as the average trace) for the remainder of the cell.

### EXAMPLE 8

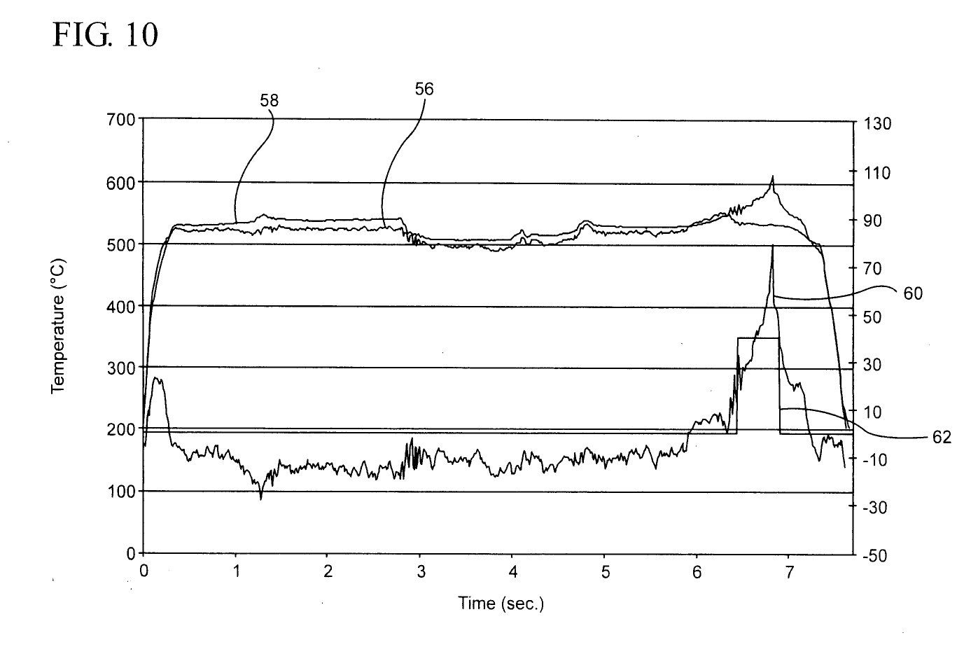

FIG. 10 is a thermal signature of delamination showing actual trace 56, average trace 58 and delta trace 60. In this case there was no contact between the frit and cover sheet during laser sealing due to a defect. This prevented heat transfer from the dispensed frit to the cover sheet causing the frit temperature to rise above the average temperature. In this case the gap between the frit and coversheet was caused by a dispensed glob of frit. The sealed cell failed hermeticity testing carried out using the water immersion test. FIG. 10 shows another advantage of using thermal signatures, the ability to use histograms (peak 62) instead of the actual peaks. The histograms as thermal signatures can be compared from various cells rather than the peaks themselves.

What is claimed is:

1. A method of finding defects in sealing material formed as a frame line on a glass plate, comprising:
irradiating said frame line of said sealing material;
measuring a temperature of said irradiated sealing material; and
detecting a change in said temperature (ΔT) caused by a nonuniformity in said sealing material.

2. The method of claim 1, wherein said sealing material is a frit.

3. The method of claim 1, wherein said frame line of said sealing material is pre-sintered onto said glass plate.

4. The method of claim 1, wherein said frame line of said sealing material is rejected if said temperature change (ΔT) is detected.

5. The method of claim 1, wherein said irradiation is carried out by applying a laser beam onto said frame line of said sealing material.

6. The method of claim 5, wherein said temperature is measured using an optical pyrometer mounted onto a head of said laser.

7. The method of claim 6, wherein said laser is operated at a laser power P wherein P₁<P<P₂, where P₁ is a laser power that raises a temperature of said sealing material to a sensitivity of said optical pyrometer and P₂ is a laser power that raises said temperature of said sealing material to a melting point of said sealing material.

8. The method of claim 6, wherein said glass plate with a pre-sintered said frame line of said sealing material is placed over a substrate glass plate on which a thin film device is supported to position said thin film device within said frame, and said irradiation is carried out by applying a laser beam onto said frame line of said sealing material at a power effective to seal said sealing material to said substrate glass plate.

9. The method of claim 8, comprising moving a laser beam from said laser around said frame line, comprising a feedback step wherein said laser is operated at said sealing power in an absence of said temperature change (ΔT) and operated at a lower power soon after said temperature change (ΔT) is detected, and then said power is raised back to said sealing power.

10. The method of claim 9, wherein said temperature is measured at a location that leads a location at a center of said laser beam.

11. The method of claim 1, wherein said detected temperature change (ΔT) is a condition selected from the group consisting of:
a) said ΔT>40° C. on sides of said frame line,
b) said ΔT>60° C. near corners of said frame line, and
c) said ΔT<20° C. as a temperature decrease on sides and near corners of said frame line.

12. The method of claim 11, comprising rejecting said frame line when said temperature change ΔT conditions a), b) or c) occur.

13. The method of claim 11, comprising viewing with an optical microscope said frame line or said glass plate if any of said a), b) or c) ΔT conditions occur to characterize a defect therein.

14. A method of hermetically sealing a thin film device between glass plates, comprising:
dispensing sealing material on a cover glass plate in the form of a frame line cell;
pre-sintering said sealing material onto said cover glass plate;
cooling said pre-sintered sealing material;
moving a laser beam around said frame line on said sealing material;
measuring a temperature of said sealing material contacted with said laser beam; and
detecting a change in said temperature (ΔT) caused by a nonuniformity in said sealing material.

15. The method of claim 14, wherein said cover glass plate has at least one of said cells pre-sintered thereon and a substrate glass plate has at least one thin film device formed thereon, comprising positioning said cover glass plate such that said frame line of said sealing material is disposed around an outside of said thin film device and applying said laser beam at a power effective to seal said sealing material to said substrate glass plate.

16. The method of claim 14, comprising using an infrared imaging device to observe said sealing material while said cover glass plate and said sealing material are inside a furnace during said pre-sintering and detecting said temperature change (ΔT) based on said observation.

17. The method of claim 15, wherein said temperature measuring step includes obtaining temperature versus time data for each of said cells, said time being the time in which said laser travels around said cell while obtaining said measured temperature;
further comprising obtaining average said temperature versus time data for all of said cells or representative said temperature versus time data for one of said cells without said temperature change;
subtracting said temperature versus time data of a potentially defective said cell from said average data or from said representative data to produce delta T data; and
evaluating said delta T data for said detected temperature change (ΔT).

18. The method of claim 17 comprising evaluating said delta T data for a condition selected from the group consisting of:
a) said ΔT>40° C. on sides of said frame line,
b) said ΔT>60° C. near corners of said frame line, and
c) said ΔT<20° C. as a temperature decrease on sides and near corners of said frame line.

19. The method of claim 18, comprising rejecting a cell if it satisfies any of said a), b) or c) ΔT conditions.

20. The method of claim 19, comprising viewing with an optical microscope said frame line or said glass plates of a cell that satisfies any of said a), b) or c) ΔT conditions to characterize a defect therein.
